(19) United States
(12) Patent Application Publication
(10) Pub. No.: US 2015/0095169 A1
(43) Pub. Date: Apr. 2, 2015

(54) SYSTEMS, ARTICLES AND METHODS RELATED TO RETAIL ORDERING AND FULFILLMENT, EMPLOYING WIRELESS COMMUNICATIONS

(71) Applicant: Havoc LLC, Gig Harbor, WA (US)

(72) Inventor: Eric S. Lewis, Gig Harbor, WA (US)

(73) Assignee: Havoc LLC, Gig Harbor, WA (US)

(21) Appl. No.: 14/043,631

(22) Filed: Oct. 1, 2013

(51) Int. Cl. G06Q 30/06; G06Q 20/20; G06K 7/10; G06Q 50/12

(52) U.S. Cl. CPC G06Q 30/0643; G06Q 30/0601; G06Q 50/12; G06Q 20/202; G06K 7/10366
USPC 705/15; 705/26.1; 705/27.2; 705/21; 340/10.1

(57) ABSTRACT

An order placement and fulfillment system allows orders to be automatically placed, for instance on entry to a retail establishment, permitting customers to avoid long ordering queues. An interrogation system may interrogate wireless communications devices, for instance wireless passive transponders to detect an order placement. The wireless transponder may include one or more user actuatable switches, allowing a customer to avoid unintentionally placing an order, or to select between a number of predefined orders.

### BACKGROUND

1. Technical Field

The present disclosure generally relates to ordering and fulfillment, for instance in retail environments, for example retail environments where a customer repeatedly makes the same purchases on multiple visits (e.g., coffee shops or stands, fast-food restaurants, bakeries, convenience stores).

2. Description of the Related Art

There are environments in which an individual, such as a customer, returns repeatedly for repeated purchases or instances of a given product or good. For example, coffee shops or espresso stands have become ubiquitous. Customers typically have a favorite order, for example a particular type of coffee beverage or drink and/or food item, such as a pastry. A given customer may, for instance, return to the same coffee shop or espresso stand each workday morning of the week, and order their favorite beverage (e.g., a double tall skinny latte with a shot of hazelnut syrup). The same customer may, for instance return to the same coffee shop or stand each workday afternoon, and order their favorite beverage or some alternative beverage (e.g., a frozen coffee drink). The same customer may, on the weekend, visit a different location of a chain of coffee shops or espresso stands, and either order their favorite beverage or some other beverage, along with a food item. Similar scenarios may apply at a variety of other retail locations, for example a fast-food restaurant, bagels shops, sandwich shops or other locations where food and/or beverages are sold. Such may occur at retail locations where other goods are sold, such as tobacco, newspapers, confections, ice cream, magazines, and/or any other item which an individual purchases on a habitual, routine, or periodic basis.

Often there may be a long wait at a retail environment. Such is common, for instance, at coffee shops or stands where there are fairly predictable times of peak demand (e.g., 9 AM-10 AM, 2 PM-3 PM). Dealing with these times of peak demand is taxing on the employees or retailers who must quickly process a large number of orders in a short period of time. Waiting in long lines for a desired item, such as a coffee beverage, is frustrating for customers and may even deter purchase of and satisfaction with such goods.

A new approach to ordering and fulfillment in retail environments is desirable.

### BRIEF SUMMARY

Systems, methods and articles may allow individuals to automatically place orders for items without waiting in line, for instance as the individual enters a retail location or an area proximate a retail location. The systems, methods and articles may advantageously employ wireless transponders to wirelessly place orders, for instance for items which an individual habitually, routinely or periodically orders, typically on a repeat basis. For example, an individual or customer may have a wireless transponder which contains information that allows automatic order placement on entry or approach to a retail location. The wireless transponder may, for example, take the form of a radio frequency identification (RFID) transponder or tag, for instance a passive RFID transponder or tag.

An interrogation system may include one or more antennae positioned to create an interrogation field for reading the wireless transponders. The field may, for instance encompass one or more entrances to the retail location, or an area of approach to the retail location, and/or an area within a perimeter of the retail location. Detection of a wireless transponder may generate or cause placement of an order for a particular item or good, for instance a coffee beverage or drink, either with or without an item of food.

The wireless transponder may be manually actuatable by the individual or customer via one or more manually actuatable switches, sensors or actuators. Orders may only be placed in the event that both the wireless transponder is actuated or activated and interrogated. This prevents orders being automatically placed by simply passing by or even entering a retail location. For instance, where a customer wishes to vary their order from their usual, the customer can choose not to actuate the wireless transponder. The wireless transponder may include one, two or more manually actuatable switches, sensors or actuators, each associated with a respective set of items to be ordered. This allows a customer to have more than one defined or favorite order. Thus, the customer may place one type of order on workday mornings and a different type of order on weekend mornings.

Further, orders may be determined based at least in part on time of detection or placement of the order. For instance, detection of an actuated wireless transponder in the morning hours may, for example, cause placement of an order for a hot coffee beverage. Detection of the actuated wireless transponder in the afternoon hours may, for example, cause placement of an order for a cold coffee beverage.

A wireless transponder may be summarized as including at least one antenna; at least one nontransitory medium that stores at least a first identifier; at least a first user actuatable switch having a first state and at least a second state, the first user actuatable switch selectively operable by a person in possession of the wireless transponder to place the first user actuatable switch into at least one of the first or the second states; and at least one circuit coupled to the antenna and operable to modulate a return signal with information indicative of the stored first identifier only when the first user actuatable switch is in the second state.

The at least one circuit may include a radio front end with at least one rectifier that derives direct current power from an interrogation signal received via the antenna and which includes at least one storage capacitor electrically coupled to the at least one rectifier to temporarily store the derived direct current power, the wireless transponder may be a passive wireless transponder, and the at least one circuit may modulate the return signal with information indicative of the stored first identifier only in response to a combination of receipt of the interrogation signal and the first user actuatable switch being in the second state. The at least one switch may be a normally open switch which is normally in the first state while not activated by the person in possession of the wireless transponder. The first identifier may be logically associable with an item being ordered from a list of orderable items. The first identifier may be logically associable with a coffee drink type being ordered from a list of orderable items. The first identifier may be logically associable with a combination of items being ordered from a list of orderable items. The first identifier may be logically associable uniquely with a combination of at least one item being ordered and an account to which a cost of the item is to be debited. The first identifier may be logically associable uniquely with a combination of at least one item being ordered and an account to which a cost of the item is to be charged. The at least one nontransitory medium may store at least a second identifier, and may further include at least a second user actuatable switch having a first state and at least a second state, the second user actuatable switch selectively operable by the person in possession of the wireless transponder to place the second user actuatable switch into at least one of the first or the second states, and wherein the at least one circuit may be operable to modulate the return signal with information indicative of the stored second identifier only when the second user actuatable switch is in the second state. At least one nontransitory medium may store at least a second identifier, and may further include at least a second user actuatable switch having a first state and at least a second state, the second user actuatable switch selectively operable by the person in possession of the wireless transponder to momentarily place the second user actuatable switch into the second state from the first state, and wherein the at least one circuit may be operable to modulate the return signal with information indicative of the stored second identifier only in response to receipt of an interrogation signal and the second user actuatable switch having been momentarily placed into the second state. The first identifier may be logically associable with a first set of items being ordered from a list of orderable items, and the second identifier may be logically associable with a second set of items being ordered from the list of orderable items, the second set of items different at least in part from the first set of items, each of the first and the second sets having at least one respective item. The first identifier may be logically associable with a first type of coffee drink, and the second identifier may be logically associable with a second type of coffee drink.

The wireless transponder may further include a housing; and a human-readable indicia carried by the housing and indicative of a retailer from which an item may be ordered by actuation of at least the first user actuatable switch.

The wireless transponder may further include a housing; and a human-readable indicia carried by the housing and indicative of an item which may be ordered by actuation of at least the first user actuatable switch.

The wireless transponder may further include a housing, wherein the first user actuatable switch may be operable in response to a touch on a portion of the housing.

The wireless transponder may further include a housing, wherein the first user actuatable switch may be engageable from an exterior of the housing.

A method of operating a wireless transponder may be summarized as including receiving a first interrogation signal at a first time; and in response to both receipt of the first interrogation signal and a first user actuatable switch being in a second state, the second state different from a first state of the first user actuatable switch, returning a first return signal modulated with a first identifier that is stored in a nontransitory processor-readable medium of the wireless transponder.

The method of operating a wireless transponder may further include receiving a second interrogation signal at a second time; and in response to both receipt of the second interrogation signal and a second user actuatable switch being in a second state, the second state different from a first state of the second user actuatable switch, returning a second return signal modulated with a second identifier that is stored in a nontransitory processor-readable medium of the wireless transponder.

Returning a first return signal modulated with a first identifier may include returning the first return signal with the first identifier which may be logically associable with an item being ordered from a list of orderable items. Returning a first return signal modulated with a first identifier may include returning the first return signal with the first identifier which may be logically associable with a coffee drink type being ordered from a list of orderable items. Returning a first return signal modulated with a first identifier may include returning the first return signal with the first identifier which may be logically associable uniquely with a combination of at least one item being ordered and an account to which a cost of the item is to be at least debited or charged.

A method of operating a retail fulfillment system may be summarized as including, for each of a plurality of customers, establishing a respective customer account via at least one computer system, the at least one computer including at least one processor and at least one nontransitory processor-readable medium communicatively coupled to the at least one processor; for each of at least some of the customers, logically associating at least one identifier stored in a wireless transponder with the respective customer account; and for each of the identifiers, logically associating the respective identifier at least with order information which specifies at least a type of at least one item from a list of orderable items.

The method of operating a retail fulfillment system may further include, for each of at least some of the customer accounts, logically associating at least one of a debit account or credit account with the respective customer account by the at least one computer system.

The method of operating a retail fulfillment system may further include receiving information contained in a first return signal returned by a first wireless transponder at a first time; determining a first order based on information derived from the received first return signal; and causing a notification to be provided identifying at least one item of the first order to be provided to a first customer.

Determining a first order based on derived information from the received first return signal may include identifying a respective one of the customer accounts based on the information derived from the received first return signal, and identifying a saved first order specification logically associated with the respective customer account.

The method of operating a retail fulfillment system may further include automatically debiting or charging a financial account logically associated with the identified customer account for an amount associated with the first order specification.

Determining a first order based on derived information from the received first return signal may include identifying a respective one of the customer accounts based on the information derived from the received first return signal, and selecting between a saved first order specification and a saved second order specification, each logically associated with the respective customer account, based at least in part of the derived information.

The method of operating a retail fulfillment system may further include receiving information contained in a second return signal returned by a second wireless transponder at a second time; determining a second order based on information derived from the received second return signal; and causing a notification to be provided identifying at least one item of the second order to be provided to the first customer.

The method of operating a retail fulfillment system may further include receiving information contained in a second return signal returned by the first wireless transponder at a second time; determining a second order based on information derived from the received second return signal; and causing a notification to be provided identifying at least one item of the second order to be provided to the first customer.

Receiving information contained in a first return signal returned by a first wireless transponder at a first time may include receiving information at the computer system from an interrogation system located at least proximate an entrance or a point-of-sale location, the computer system remotely located from the point-of-sale location. Causing a notification to be provided identifying at least one item of the first order to be provided to a first customer may include transmitting the notification to a point-of-sale location from the computer system which may be remotely located from the point-of-sale location.

The wireless transponder may further cause at least one indicator to provide an indication perceivable from an exterior of the wireless transponder in response to at least one of receiving information or determining the first order.

The method of operating a retail fulfillment system may further include providing a user interface that includes an order specification tool that allows a respective customer to define at least one respective order specification to be logically associated with a respective customer account and which specifies at least one item from a list of items.

The method of operating a retail fulfillment system may further include providing a user interface that includes an order specification tool that allows a respective customer to define at least one respective order specification to be logically associated with a respective customer account and which specifies at least one type of coffee drink from a menu of available beverage and food items.

The method of operating a retail fulfillment system may further include providing a user interface that includes an order specification tool that allows a respective customer to define at least one respective order specification based on at least one of a time of day or day of week to be logically associated with a respective customer account and which specifies at least one item from a list of items.

The method of operating a retail fulfillment system may further include receiving a first return signal returned by a first wireless transponder; determining a first order based on information derived from the received first return signal and based on a current time of day; and causing a notification to be provided to identify at least one item of the order to be provided to a first customer.

The method of operating a retail fulfillment system may further include receiving a first return signal returned by a first wireless communications device; determining a first order based on information derived from the received first return signal and based on at least one of a current time of day or a current day of week; and causing a notification to be provided to identify at least one item of the order to be provided to a first customer.

A retail fulfillment system may be summarized as including at least one computer including at least one processor and at least one nontransitory processor-readable medium communicatively coupled to the at least one processor, the at least one computer: for each of a plurality of customers, establishes a respective customer account via at least one computer system; for each of at least some of the customers, logically associates at least one identifier stored in a wireless transponder with the respective customer account; and for each of the identifiers, logically associates the respective identifier at least with order information which specifies at least a type of at least one item from a list of orderable items.

For each of at least some of the customer accounts, the at least one computer system may logically associate at least one of a debit account or credit account with the respective customer account. The at least one computer system may receive information contained in a first return signal returned by a first wireless transponder at a first time; determine a first order based on information derived from the received first return signal; and cause a notification to be provided identifying at least one item of the first order to be provided to a first customer. The at least one computer system may identify a respective one of the customer accounts based on the information derived from the received first return signal, and may identify a saved first order specification logically associated with the respective customer account. The at least one computer system may automatically debit or charge a financial account logically associated with the identified customer account for an amount associated with the first order specification. The at least one computer system may identify a respective one of the customer accounts based on the information derived from the received first return signal, and may select between a saved first order specification and a saved second order specification, each logically associated with the respective customer account, based at least in part of the derived information. The at least one computer system may receive information contained in a second return signal returned by a second wireless transponder at a second time; may determine a second order based on information derived from the received second return signal; and may cause a notification to be provided identifying at least one item of the second order to be provided to the first customer. The at least one computer system may receive information contained in a second return signal returned by the first wireless transponder at a second time; may determine a second order based on information derived from the received second return signal; and may cause a notification to be provided identifying at least one item of the second order to be provided to the first customer. The at least one computer system may receive information at the computer system from an interrogation system located at least proximate an entrance of a point-of-sale location, the computer system which may be remotely located from the point-of-sale location. The at least one computer system may transmit the notification to a point-of-sale location from the computer system which may be remotely located from the point-of-sale location. The at least one computer system may provide a user interface that may include an order specification tool that allows a respective customer to define at least one respective order specification to be logically associated with a respective customer account and which may specify at least one item from a list of items. The at least one computer system may provide a user interface that may include an order specification tool that may allow a respective customer to define at least one respective order specification to be logically associated with a respective customer account and which may specify at least one type of coffee drink from a menu of available beverage and food items. The at least one computer system may provide a user interface that may include an order specification tool that may allow a respective customer to define at least one respective order specification based on a time of day to be logically associated with a respective customer account and which may specify at least one item from a list of items. The at least one computer system may receive a first return signal returned by a first wireless transponder; may determine a first order based on information derived from the received first return signal and based on a current time of day; and may cause a notification to be provided to identify at least one item of the order to be provided to a first customer.

The at least one computer system may receive a first return signal returned by a first wireless communications device; may determine a first order based on information derived from the received first return signal and based on at least one of a current time of day or a current day of week; and may cause a notification to be provided to identify at least one item of the order to be provided to a first customer.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic view of an order placement and fulfillment system in a retail environment populated by employees and customers, the order placement and fulfillment system including a wireless interrogation system which interrogates wireless transponders carried by some of the customers, a retail location based order placement and fulfillment system processor-based component, a retail location based order display terminal, and a back end order placement and fulfillment system processor-based component, all or some of which are communicatively coupleable to a plurality of customer processor-based devices and/or financial debit or credit network systems, according to one illustrated embodiment.

FIG. 2 is a functional block diagram of portions of the order placement and fulfillment system of FIG. 1, according to one illustrated embodiment.

FIG. 3 is a functional block diagram of a wireless transponder for use with the order placement and fulfillment system of FIG. 1, according to one illustrated embodiment.

FIG. 4 is a functional block diagram of a wireless transponder for use with the order placement and fulfillment system of FIG. 1, according to one illustrated embodiment.

FIG. 5 is a flow diagram showing a high level method of operation of a wireless communications device, for example a wireless transponder, in an order placement and fulfillment system, according to one illustrated embodiment.

FIG. 6 is a flow diagram showing a low level method of operation of a wireless transponder, according to one illustrated embodiment, useful in performing the method of FIG. 5.

FIG. 7 is a flow diagram showing a high level method of operation of an order placement and fulfillment system processor-based component, according to one illustrated embodiment, including the setting up of customer accounts.

FIG. 8 is a flow diagram showing a high level method of operation of an order placement and fulfillment system processor-based component, according to one illustrated embodiment, including the interrogation of wireless transponders and automated order placement.

FIG. 9 is a flow diagram showing a high level method of operation of an order placement and fulfillment system processor-based component, according to one illustrated embodiment, which may be performed in conjunction with the method of FIG. 8.

FIG. 10 is a flow diagram showing a high level method of operation of an order placement and fulfillment system processor-based component, according to one illustrated embodiment, which may be performed in conjunction with the method of FIG. 8.

FIG. 11 is a flow diagram showing a low level method of operation of an order placement and fulfillment system processor-based component, according to one illustrated embodiment, which may be performed as part of the method of FIG. 8.

FIG. 12 is a flow diagram showing a high level method of operation of an order placement and fulfillment system processor-based component, according to one illustrated embodiment, allowing customers to logically associate customized orders with wireless transponders via customer accounts.

FIG. 13 is a flow diagram showing a high level method of operation of an order placement and fulfillment system processor-based component, according to one illustrated embodiment, allowing customers to logically associate customized orders with wireless transponders via customer accounts on a date or time basis.

FIG. 14 is a flow diagram showing a high level method of operation of an order placement and fulfillment system processor-based component, according to one illustrated embodiment, where order selection is based on at least one of day of week or time of day that the order is received.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications devices including wireless transponders such as active or passive radio frequency identification (RFID) transponders or tags, point-of-sale (POS) terminals, computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

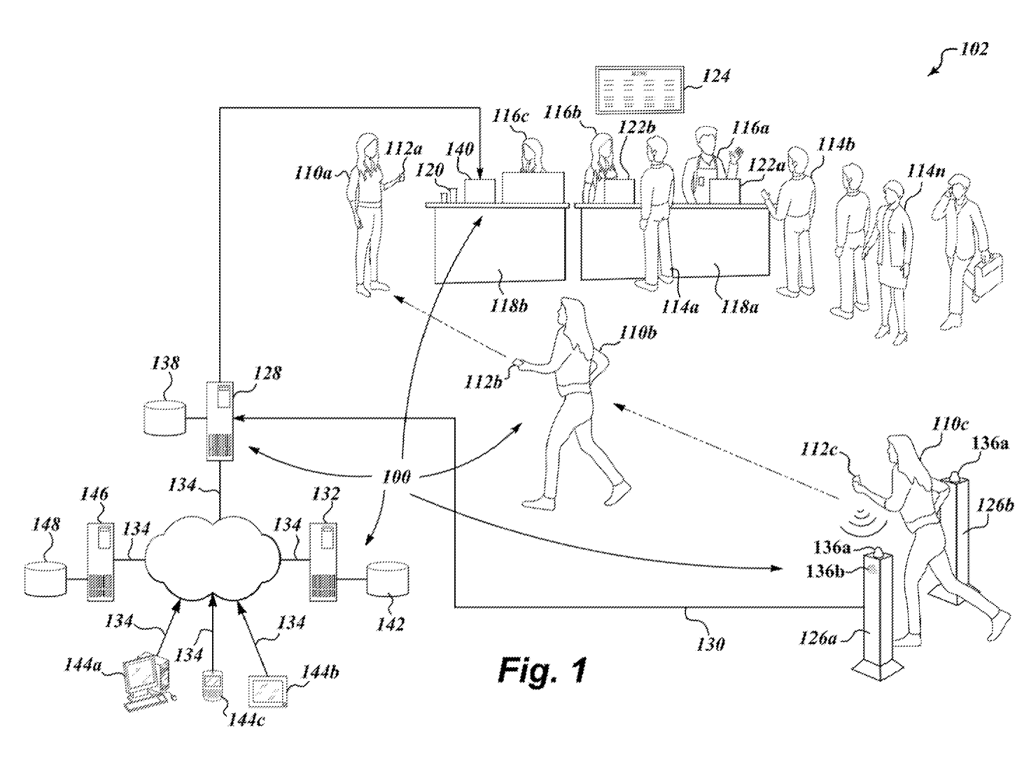

FIG. 1 shows an order placement and fulfillment system 100 for use in a retail environment 102, according to one illustrated embodiment, along with various end user devices 144a-144c (only three shown, collectively 144) and financial debit or credit network systems 146 (only one shown).

As described in detail herein, the order placement and fulfillment system 100 allows certain customers 110a, 110b, 110c (collectively 110) who carry or bear wireless communications devices 112a, 112b, 112c (three shown, collectively 112) to avoid waiting in lines or queues of other customers 114a-114n (collectively 114) to place orders for items, goods or services.

The retail environment 102 can take any of a large variety of forms. For example, the retail environment 102 may take the form of coffee shops or stands, fast-food restaurants, bakeries, bagel shops, sandwich shops, ice cream stores or stands, convenience stores, or virtually any retail location at which items or goods or services may be ordered. While generally described herein in terms of a coffee shop, one will recognize that the teachings herein are applicable to a wide variety of other types of retail environments.

As illustrated in FIG. 1, the retail environment 102 includes various retail personnel (e.g., sales clerks or associates) 116a, 116b, 116c (three shown, collectively 116). The retail environment 102 will typically include one or more counters 118a, 118b (two shown, collectively 118) at which at which items or goods or services 120 (only one shown) may be ordered by customers 114. The counter(s) 118 typically includes one or more point-of-sale (POS) terminals 122a, 122b (collectively 122). The POS terminals 122 allow the retail personnel 116 to “ring up” sales. This may include accepting cash, credit and/or debit cards for payment. The POS terminals 122 may also generate order requests, itemizing the items, goods or services that constitute a given order. The POS terminals 122 may additionally or alternatively generate receipts for a sales transaction, whether in paper or electronic form. Some retail environments 102 may omit dedicated counters 118, relying on retail personnel 116 to circulate around the retail space 102, engaging customers 110, 114. In such retail environments 102, the retail personnel 116 typically carry a portable POS terminal (not shown), for instance a mobile phone or tablet computer device, typically with magnetic stripe reader.

The retail environment 102 will typically include one or more counters 118b or other locations at which the items or goods may be picked up when ready. Some retail environments 102 may include one or more lists of items or goods which are available, for example menus 124 listing food (e.g., sandwiches, pastries) and/or drinks (e.g., coffee beverages).

The illustrated order placement and fulfillment system 100 includes one or more interrogation subsystems 126a, 126b (collectively 126) and one or more retail location based order placement and fulfillment subsystems 128, communicatively coupled to the interrogation system via one or more communications channels 130 (e.g., wired, wireless communications networks).

The illustrated order placement and fulfillment system 100 also includes one or more “back office” or “support” order placement and fulfillment subsystems 132. The back office order placement and fulfillment subsystem 132 may support providing services to two or more separate retail locations 102, thus may be located remotely from one or more retail locations 102. The retail location based order placement and fulfillment subsystem(s) 128 are communicatively coupled to the back office order placement and fulfillment subsystem 132 via one or more communications channels 134 (e.g., wired, wireless communications networks). While illustrated as separate components, the retail location based order placement and fulfillment subsystems 128 and back office or support order placement and fulfillment subsystems 132 may be combined into a combined subsystem which performs functions which might otherwise be distributed between subsystems.

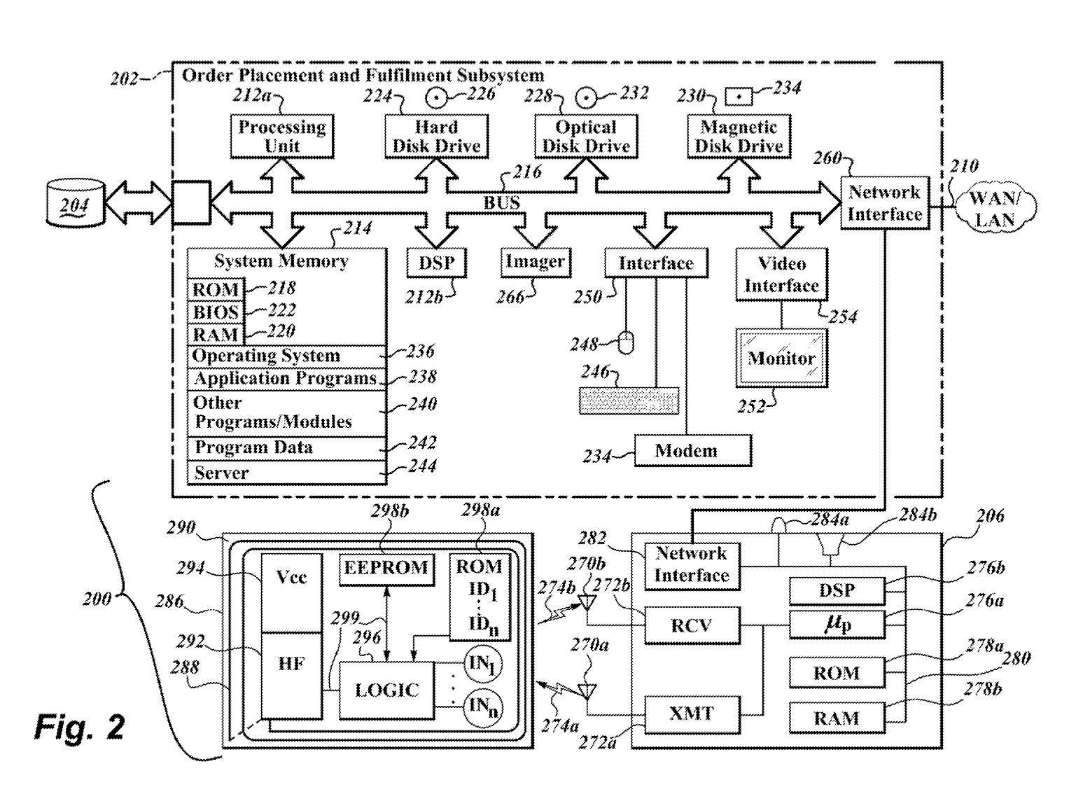

The interrogation system 126 interrogates wireless communications devices of customers, for example wireless transponders such as radio frequency identification (RFID) transponders or tags 112. As described in more detail below in reference to FIG. 2, the interrogation system 126 includes one or more antennas, transmitters, receivers, transceivers (collectively radios, not illustrated in FIG. 1), to read information from wireless communications devices of customers, for example RFID transponders or tags 112.

The interrogation system 126 may produce, generate or emit interrogation signals. Such may, for example, be useful where the wireless transponders 112 are passive devices, deriving electrical power for operation from received interrogation signals. The interrogation system 126 may have antennas positioned proximate an entrance or entryway or passage into the retail location 102. Additionally or alternatively, interrogation system 126 may have antennas positioned proximate a point-of-sale location, for instance proximate a POS terminal 122 or counter 118. Additionally or alternatively, interrogation system 126 may have antennas positioned to provide wireless coverage throughout all or a portion of the retail location 102.

The interrogation system 126 is illustrated as two kiosks, however it can be implemented in many different forms. For example, the interrogation system 126 may include a number of discreetly placed antennas (e.g., within a doorframe or wall), and a controller located in a discreet location. The interrogation system 126 preferably includes one or more indicators 136a, 136b (collectively 136) which are operable to provide a discernible indication to customers 110 indicative that the interrogation system has read their respective RFID transponders or tags 112, and/or that their orders have been placed. The indicators 136 may take the form of visible indications, for instance one or more lights (e.g., incandescent lights, light emitting diodes (LEDs)), display screens (e.g., liquid crystal diode (LCDs)), etc., 136a. The indicators 136 may take the form of aural or audible indications, for instance one or more speakers 136b.

In various implementations, the interrogation system 126 may read a variety of information from the RFID transponders or tags 112. For example, RFID transponders or tags 112 typically store a unique wireless transponder identifier in read-only nonvolatile memory, the unique wireless transponder identifier which uniquely identifies the RFID transponders or tags 112 from all other RFID transponders or tags 112 of a given manufacturer or distributor. The interrogation system 126 may read the unique wireless transponder identifier from the RFID transponders or tags 112. Some RFID transponders or tags 112 have writeable nonvolatile memory. Such may store an identifier that uniquely identifies a customer, a customer account, or even one or more defined orders for the items, goods or services available at a retail establishment (e.g., chain of coffee shops). The interrogation system 126 may read the identifier that uniquely identifies a customer, a customer account, or defined order from the RFID transponders or tags 112.

The retail location based order placement and fulfillment subsystem 128 receives information read by the interrogation subsystem 126 from the wireless communications devices, for instance RFID transponders or tags 112. The retail location based order placement and fulfillment subsystem 128 may process the read information. For example, the retail location based order placement and fulfillment subsystem 128 may discern order specifications from the read information.

For instance, the retail location based order placement and fulfillment subsystem 128 may decode order information encoded in a return signal (e.g., backscatter signal) which specifies order information. Also for instance, the retail location based order placement and fulfillment subsystem 128 may decode a unique wireless transponder identifier from a return signal. The retail location based order placement and fulfillment subsystem 128 may then logically associate the unique wireless transponder identifier with an order, either directly, or via a customer or customer account. For instance, the retail location based order placement and fulfillment subsystem 128 may decode the unique wireless transponder identifier from the return signal, then logically associate the unique wireless transponder identifier with a customer identifier or customer account identifier. The retail location based order placement and fulfillment subsystem 128 may discern the order specification based at least in part on stored order information which is logically associated to the customer identifier or customer account identifier.

In some implementations or instances the retail location based order placement and fulfillment subsystem 128 may include one or more nontransitory processor- or computer-readable media 138. The nontransitory processor- or computer-readable media 138 may include a database or other data structure which stores one or more of: customer identifiers, customer account identifier, order specifications, customer identity information, financial account information (e.g., credit and/or debit account numbers, expiration dates, security codes), and/or rewards account information, data or statistics.

In some implementations or instances, the retail location based order placement and fulfillment subsystem 128 may query the back office order placement and fulfillment subsystem 132 in discerning the order specification. For instance, the retail location based order placement and fulfillment subsystem 128 may query the back office order placement and fulfillment subsystem 132 for order specifications using the unique wireless transponder read from the wireless communications devices of customers, for example RFID transponders or tags 112. Also for instance, the retail location based order placement and fulfillment subsystem 128 may query the back office order placement and fulfillment subsystem 132 for order specifications using the customer identifier or customer account identifier, which were either read directly from the RFID transponders or tags 112, or were identified by the retail location based order placement and fulfillment subsystem 128 based on the unique wireless transponder read from the wireless communications devices of customers, for example RFID transponders or tags 112.

The retail location based order placement and fulfillment subsystem 128 may include, or be communicatively coupled to, an order presentation component 140. The order presentation component 140 presents orders to retail personnel 116c who are responsible for preparing the order. For example, the order presentation component 140 may visually display and/or orally announce the order to a barista for preparation. Oral announcement, either by recorded or synthesized voice may be particularly beneficial in environments where other non-automated orders are called out by the other retail personnel 116a, 116b, such as is common in a coffee shop.

The back office order placement and fulfillment subsystem 132 may perform a variety of functions depending on the particular implementation. For example, the back office order placement and fulfillment subsystem 132 may establish logical relationships between unique wireless transponder identifiers and customers and/or customer accounts.

In some implementations or instances the back office order placement and fulfillment subsystem 132 may include one or more nontransitory processor- or computer-readable media 142. The nontransitory processor- or computer-readable media 142 may include a database or other data structure which stores one or more of: customer identifiers, customer account identifier, order specifications, customer identity information, financial account information (e.g., credit and/or debit account numbers, expiration dates, security codes), and/or rewards account information, data or statistics.

The back office order placement and fulfillment subsystem 132 may serve as a front or forward facing customer portal, allowing customers 110 to define one or more standard orders, each of which specifies particular items, goods or services that constitute the order. For example, the back office order placement and fulfillment subsystem 132 may allow a customer to define a workday morning order for a skinny tall latte with two shots of hazelnut syrup and a Danish. Also for example, the back office order placement and fulfillment subsystem 132 may allow a customer to define a workday afternoon order for a frozen coffee beverage without whipped cream. As a further example, the back office order placement and fulfillment subsystem 132 may allow a customer to define a weekend breakfast order for an egg and bacon sandwich and a Grande Americano with room.

In serving as a front or forward facing customer portal, the back office order placement and fulfillment subsystem 132 may provide an interface, for instance a Web based interface, which allows customers 110 to set up and manage respective customer accounts via various customer processor-based communications devices 144. The customer processor-based communications devices may take any of a large variety of forms including computers (e.g., desktop computers, laptop computers, netbook computers) 144a, tablet computers 144b, smartphones 144c, or other processor-based devices which are capable of wired or wireless communications via one or more wired and/or wireless communications channels 134.

The customer processor-based communications device(s) 206 will typically take the form of end user processor-based devices, for instance, personal computers (e.g., desktop or laptop computers), net book computers, tablet computers, smartphones, personal digital assistants, workstation computers and/or mainframe computers, and the like, executing appropriate instructions. These customer processor-based communications devices 206 may be communicatively coupled to one or more server computers. For instance, customer processor-based communications devices 206 may be communicatively coupled externally via one or more intermediate server computers (not shown), routers or bridges, which may implement a firewall. The customer processor-based communications devices 206 may execute a set of client instructions to function as a client of the server computer(s), which are communicatively coupled via a WAN.

The back office order placement and fulfillment subsystem 132 may provide a Web interface that includes various pull-down menus, tabs, user selectable icons, input fields, scroll bars, and dialog boxes, as well as other user interface components. The Web interface allows a customer 110 to create a customer account using the customer's communications device(s) 144. The customer may enter their full name, screen name or nickname, address, date of birth, and/or favorite retail location(s). The customer may optionally enter financial account information, for instance an account number, expiration date, and validation or security code associated with a charge or debit account. This allows automated charging or debiting on purchase of items, goods or services by the customer.

The customer may use the Web interface to create order specifications, which detail various items, goods or services which constitute the order. For example, the customer may define a workday morning order for a skinny tall latte with two shots of hazelnut syrup and a Danish. Also for example, the customer may define a workday afternoon order for a frozen coffee beverage without whipped cream. As a further example, the customer may define a weekend breakfast order for an egg and bacon sandwich and a Grande Americano with room.

The customer may create or define a logical association between the respective orders and a respective wireless communications device, for example RFID transponders or tags 112. Such may employ unique wireless transponder identifiers stored in the RFID transponders or tags 112. For example, the unique wireless transponder identifiers may be logically associated with a customer identifier or customer account, for example by retail personnel 116 at the retail location when the RFID transponder(s) or tag(s) 112 is issued or provided to the customer. Alternatively, the RFID transponders or tags 112 may bear or carry or be physically associated with (e.g., removable sticker) a code which the customer can enter into the Web interface to create or define a logical association between the unique wireless transponder identifier of the particular the RFID transponder or tag 112 and the customer identifier or customer account identifier. The code may, and likely will, be different from the unique wireless transponder identifier, for example being shorter than the unique wireless transponder identifier. The code may, for instance, take the form of a combination of digits and letters. The back office order placement and fulfillment subsystem 132 may store a logical relationship between the code and respective unique wireless transponder identifier. On receipt of the code, as entered by the customer, the back office order placement and fulfillment subsystem 132 creates or defines a logical relationship between the unique wireless transponder identifier and the customer identifier or customer account identifier.

The customer may create or define a logical association between the respective orders and each of a number of states of wireless communications device, for example RFID transponders or tags 112. Additionally or alternatively, the customer may create or define a logical association between the respective orders and each of a number of times of day or day of week. For instance, a first customer may define a logical association between a first order specification (e.g., skinny tall latte with two shots of hazelnut syrup and a Danish) and weekdays between 8 AM and 10 AM. The first customer may also define a logical association between a second order specification (e.g., frozen coffee beverage without whipped cream) and weekdays between 1 PM and 4 PM. The first customer may further define a logical association between a third order specification (e.g., an egg and bacon sandwich and a Grande Americano with room) and weekend mornings. The customer may create or define customized orders to their own particular tastes. The logical association is an association or relationship between at least two values, which is stored in a computer- or processor-readable form in nontransitory computer- or processor-readable media and hence operable via machine logic.

The customer account may additionally include customer communications device address information (e.g., uniform resource locator or URL, phone number, SIM or international mobile subscriber identifier (ISMI), mobile equipment identifier, MAC address) for one or more processor-based customer communications devices 144. Entry into the Web interface to create and/or manage a customer's account information may require entering of a user name and a password by the customer, and verification of the user name and password by the back office order placement and fulfillment subsystem 132.

The retail location based order placement and fulfillment subsystem 128 and/or the back office order placement and fulfillment subsystem 132 may be communicatively coupled to one or more financial accounts network computer systems 146 and/or associated databases 148 via one or more communications channels 134. The financial accounts network computer systems 146 and/or associated databases 148 may be owned and/or operated by third party financial services organizations (e.g., banks, credit card or debit card companies) or by an entity that owns, runs, or is otherwise associated with a retailer (e.g., prepaid coffee shop cards or gift cards, whether in tangible or electronic forms). The retail location based order placement and fulfillment subsystem 128 and/or the back office order placement and fulfillment subsystem 132 may automatically charge or debit a respective financial account of a customer on receipt of each order placed via the wireless communications device, for example RFID transponders or tags 112. The customer may have provided the required information via the customer account which the customer set up using the Web interface.

The various systems, subsystems, and/or processor-based devices are capable of communications, for example via one or more networks 134 (e.g., Wide Area Networks, Local Area Networks), for instance packet switched communications networks, such as the Internet, Worldwide Web portion of the Internet, extranets, intranets, and/or various other types of telecommunications networks such as cellular phone and data networks, and plain old telephone system (POTS) networks. The type of communications infrastructure should not be considered limiting. The communications network(s) may take any of a large variety of forms, and may include modems (e.g., DSL modem, cable modem), routers, network switches, and/or bridges, etc.

While often illustrated as a single nontransitory computer- or processor-readable storage medium, in many implementations each of the various illustrated nontransitory computer- or processor-readable storage media may constitute a plurality of nontransitory storage media. The plurality of nontransitory storage media may be commonly located at a common location, or distributed at a variety of remote locations. Database(s) may be stored separately from one another on separate computer- or processor-readable storage medium or may be stored on the same computer- or processor-readable storage medium as one another. Various computer- or processor-readable storage medium may be co-located with the corresponding computer systems, for example, in the same room, building or facility. Alternatively, various computer- or processor-readable storage medium may be located remotely from the corresponding computer systems (e.g., server computer systems) for example, in a different facility, city, state or country. Electronic or digital information, files or records or other collections of information may be stored at specific locations in non-transitory computer- or processor-readable media, thus are logically addressable portions of such media, which may or may not be contiguous.

While FIG. 1 illustrates a representative networked environment, typical networked environments may include many additional computer systems and entities. The concepts taught herein may be employed in a similar fashion with more populated networked environments than that illustrated in FIG. 1. For example, there may be hundreds or even thousands of retail locations 102, and associated the retail location based order placement and fulfillment subsystem 128. There are likely hundreds, if not thousands or even millions of customers 110 and wireless transponders 112. There may be more than one back office order placement and fulfillment subsystem 132, for example located in different countries or regions within a country. There may be more than one financial accounts network computer systems 146 and/or associated databases 148.

FIG. 2 and the following discussion provide a brief, general description of a suitable networked environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices (e.g., smartphones, tablet devices, netbooks, personal digital assistants), multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked environment 200 comprising one or more order placement and fulfillment subsystems 202 (only one illustrated) and one or more associated nontransitory computer- or processor-readable storage medium 204 (only one illustrated). The networked environment 200 may also comprise an interrogation system 206, which interrogates wireless communications devices, e.g., RFID transponders or tags 286a in the vicinity of the interrogation system.

The order placement and fulfillment subsystems 202 may be retail location based, back office or support based, or may provide the combined functionality of the previously discussed retail location based subsystem 128 and back office or support subsystem 132. The associated nontransitory computer- or processor-readable storage medium 204 is communicatively coupled to the order placement and fulfillment subsystem(s) 202 via one or more communications channels, for example, one or more parallel cables, serial cables, or wireless channels capable of high speed communications, for instance, via FireWire®, Universal Serial Bus® (USB) 2 or 3, and/or Thunderbolt®, Gigabyte Ethernet®.

In operation, the interrogation system 206 reads information from wireless communications devices, for example RFID transponders or tags 286, in the vicinity or range of antennas of the interrogation system 206. The order placement and fulfillment subsystems 202 use the information read from the RFID transponders or tags 286 by the interrogation system 206 to register an order for the customer, charge or debit a purchase price of the order to an account, allowing the customer to bypass an ordering queue or line, if one exists, or otherwise simplifying the ordering process. Specific exemplary implementations of the order placement and fulfillment subsystems 202, interrogation system 206, and RFID transponders or tags 286 are discussed below. It should be noted that these implementations are representative, and various modification may be made to one or more of these components.

The networked environment 200 may employ other computer systems and network equipment, for example, additional servers, proxy servers, firewalls, routers and/or bridges. The order placement and fulfillment subsystem(s) 202 will at times be referred to in the singular herein, but this is not intended to limit the embodiments to a single device since in typical embodiments there may be more than one order placement and fulfillment subsystem(s) 202 involved. Unless described otherwise, the construction and operation of the various blocks shown in FIG. 2 are of conventional design. As a result, such blocks need not be described in further detail herein, as they will be understood by those skilled in the relevant art.

### Order Placement and Fulfillment Subsystem

The order placement and fulfillment subsystem(s) 202 may include one or more processing units 212a, 212b (collectively 212), a system memory 214 and a system bus 216 that couples various system components, including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), programmable logic units (PLUs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the order placement and fulfillment subsystem(s) 202, such as during start-up.

The processing unit(s) 212 may be any logic processing unit, such as one or more central processing units (CPUs), digital signal processors (DSPs), application-specific integrated circuits (ASICs), field programmable gate arrays (FPGAs), graphical processing units (GPUs), etc. Non-limiting examples of commercially available computer systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, a 68xxx series microprocessor from Motorola Corporation, an ATOM processor, or an A4 or A5 processor. Unless described otherwise, the construction and operation of the various blocks in FIG. 2 are of conventional design. As a result, such blocks need not be described in further detail herein, as they will be understood by those skilled in the relevant art.

The order placement and fulfillment subsystem(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nontransitory nonvolatile storage of computer-readable instructions, data structures, program modules and other data for the order placement and fulfillment subsystem 202. Although the depicted matching service server computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to receive and automatically process and/or store order and customer related information, using the associated nontransitory computer- or processor-readable storage medium 204. Application programs 238 may also include instructions that cause the processor(s) 212 to receive information read from wireless transponders 286. The read information may specify the contents of an order, a unique wireless transponder identifier, a customer identifier and/or a customer account identifier. Application programs 238 may also include instructions that cause the processor(s) 212 to automatically process the read information by identifying the contents of an order, and causing the order to be presented to retail personnel. Application programs 238 may also include instructions that cause the processor(s) 212 to automatically charge or debit a financial account associated with a customer identifier or customer account. Application programs 238 may also include instructions that cause the processor(s) 212 to confirm receipt of an order, for example via one or more visual and/or aural acknowledgements. Such may include sending information to the interrogation system 206 to cause the interrogation system to produce the visual and/or aural acknowledgement of receipt of an order or reading of a wireless transponder. Application programs 238 may also include instructions that cause the processor(s) 212 to present a Web interface or other user interface which allows customers to create and maintain (e.g., update or change parameters) of a respective customer account. Application programs 238 may further include instructions that cause the processor(s) 212 to automatically create or define logical relationships between unique wireless transponder identifiers and customer identifiers or customer account identifiers. These various aspects are described in detail herein with reference to the various flow diagrams.

Application programs 238 may include instructions that cause the processor(s) 212 to automatically establish, maintain, update or record ownership information with respect to electronic or digital documents or files or data, as well as privileges, permissions or authorizations to perform various acts on such electronic or digital documents or files such as reading, modifying, annotating, extracting, importing, retrieving, and/or deleting. Application programs 238 may even further include instructions to create entries in and/or query one or more databases which store information or data about end user client entities, regardless of location at which those electronic or digital documents or data are stored. For example, application programs 238 may include instructions that cause the processor(s) 212 to automatically control access to certain information based on certain criteria. For example, the instructions may limit other end user client entities from seeing information about a specific end user client entity, unless the specific end user client entity has previously identified the other end user client entity to receive access to the access-related information. Application programs 238 may include instructions that, for example, require authentication before access is granted to a customer account or customer account data. Such may include requiring entry of a valid pair of: 1) account name or identifier and 2) a passcode (e.g., password) to gain access to a customer account. Application programs 238 may include instructions that, for example, encrypt customer data or information, either as stored or during transmission thereof.

Application programs 238 may include instructions that cause the processor(s) 212 to automatically establish, maintain, update or record customer information, including various logical relationships defined therebetween and/or with unique wireless transponder identifiers or other unique wireless identifiers (e.g., ISMI). Such may include updating records in a database, table, or other data structure.

The system memory 214 may also include communications programs, for example, a server 244 that causes the order placement and fulfillment subsystem 202 to serve electronic information or files via the Internet, intranets, extranets, telecommunications networks, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable servers may be commercially available such as those from Mozilla, Google, Microsoft and Apple Computer.

While shown in FIG. 2 as being stored in the system memory 214, the operating system 236, application programs 238, other programs/modules 240, program data 242 and server 244 can be stored on the hard disk 226 of the hard disk drive 224, the optical disk 232 of the optical disk drive 228 and/or the magnetic disk 234 of the magnetic disk drive 230.

An operator can enter commands and information into the order placement and fulfillment subsystem(s) 202 through input devices such as a touch screen or keyboard 246 and/or a pointing device such as a mouse 248, imager 266 and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The order placement and fulfillment subsystem(s) 202 can include other output devices, such as speakers, printers, etc.

The order placement and fulfillment subsystem(s) 202 can include one or more network interfaces 260, and can operate in a networked environment 200 using logical connections 210 to one or more remote computers and/or devices. For example, the order placement and fulfillment subsystem(s) 202 can operate in a networked environment 200 using logical connections to one or more interrogation systems 206, customer communications devices 144 (FIG. 1), and/or one or more financial accounts network computer systems 146 (FIG. 1) and/or associated databases 148 (FIG. 1). Communications may be via a wired and/or wireless network architecture, for instance, wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the order placement and fulfillment subsystem(s) 202 and the end user client processor-based systems 206.

### Interrogation System

The interrogation system(s) 206 may take any of a variety of forms, an exemplary form set out in FIG. 2 and described below.

The interrogation system(s) 206 typically includes one or more antenna 270a, 270b, communicatively coupled to one or more transmitters 272a, receivers 272b, transceivers, collectively referred to herein as radios (collectively 272). The transmitter(s) 272a and associated antenna 270a generate, transmit or produce interrogation signals 274a. The receiver(s) 272b and associated antenna 270b receive response or return signals 274b returned by wireless communications devices, for example wireless RFID transponders or tags 286.

The interrogation signal 274a may, in some implementations, consist of a simple carrier wave, without any information encoded thereon or therein. The carrier wave may trigger the wireless communications devices to respond to what in essence is an interrogation or inquiry. Additionally, the carrier wave may serve as a source of power for the wireless communications devices, for instance where the wireless communications device is in the form of passive wireless transponders such as passive RFID transponders or tags 286. In other implementations, the carrier wave may have information encoded thereon or therein. Such may, for instance, address a given set of wireless communications devices 286 to respond. Such may allow two or more different retailers to employ the same wireless communications device (e.g., passive RFID transponders or tags 286) for allowing a customer to place orders for respective items, goods or services offered by the retailer. The interrogation signal 274a may, for example, fall in the radio or microwave ranges or portions of the electromagnetic spectrum. Nevertheless, reference to radio herein includes not only communications in the portion of the electromagnetic spectrum denominated as radio, but in other portions as well.

The response or return signals 274b may, for example, take the form of signals backscattered by passive RFID transponders or tags 286, with information imposed on the carrier wave or otherwise encoded in the response or return signal 274b. The information may, for example, include a unique wireless transponder identifier, stored in and that uniquely identifies the passive RFID transponder or tag 286.

The interrogation system(s) 206 may include a control subsystem comprising one or more microcontrollers, microprocessors 276a, digital signal processors (DSPs) 276b, graphical processing units (GPUs), application specific integrated circuits (ASICs), programmable logic units (PLUs), field programmable gate arrays (FPGAs), etc. The control subsystem may further comprise one or more nontransitory computer- or processor-readable storage media. For example, the control subsystem may comprise nonvolatile memory (e.g., ROM, EEPROM) 278a, volatile memory (e.g., RAM, DRAM) 278b, as well as other storage media including magnetic disks, optical disks, etc. (not shown). The control subsystem may include one or more buses 280, for example one or more power buses, instruction buses, data buses, address buses, etc. The interrogation system(s) 206 may include one or more communications interface 282, for instance one or more network interfaces or ports, which may be wired or wireless communications interfaces or ports. The communications interface 282 allows the interrogation system 206 to communicate with the order placement and fulfillment subsystems 202 using conventional communications protocols (e.g., TCP/IP, IEEE 802.11, BLUETOOTH).

The interrogation system 206 may include one or more presentation or acknowledgement devices, collectively 284. For instance, the interrogation system 206 may include one or more visual presentation or acknowledgement devices 284a, for instance lights or display screens. For instance, the interrogation system 206 may include one or more aural presentation or acknowledgement devices 284b, for instance audio speakers or transducers. The interrogation system 206 controls the presentation or acknowledgement devices 284 to provide a visual and/or aural announcement or acknowledgement when an order has been received or information read from a wireless communications device. This acknowledgement serves as a prompt for the customer to head directly to a pickup location to await the items, goods or services that were ordered. The visual announcement or indication can be as simple as activation of an LED, or as complex as presentation of a visual message that identifies the contents of the order, the customer, and/or customer account, optionally with a greeting. Likewise, the aural announcement or indication can be as simple as produce of a sound (e.g., simple beep), or as complex as presentation of an aural message that identifies the contents of the order, the customer, and/or customer account, optionally with a greeting. Additionally or alternatively, the interrogation system 206 may send or cause to be sent or transmitted an electronic announcement or acknowledgement communication (e.g., electronic or email message, text or SMS message) to one or more mobile wireless devices logically associated with the customer.

### Wireless Communications Device—Passive Wireless RFID Transponder or Tag

The wireless communications device may take any of a variety of forms, an exemplary form set out in FIG. 2 and described below as a passive wireless RFID transponder or tag 286.

The passive wireless RFID transponder or tag 286 typically includes one or more antenna 288 (one shown). The antenna 288 may take the form of a conductive trace applied to an electrically insulative substrate 290. For example, the antenna 288 may take the form of a coil or a dipole antenna formed by the electrically conductive trace.

The passive wireless RFID transponder or tag 286 may include a high frequency (e.g., radio, microwave) front end 292. The high frequency front end 292 detects interrogation signals 274a, and imposes information onto a response or return signal 274b. For example, the high frequency front end 292 may backscatter the response or return signal 274b. In some implementations, the high frequency front end 292 initially decodes or retrieves information modulated on the carrier wave of the interrogation signal 274a, for example converting such into a bit string. Where the wireless communications device is passive, the high frequency front end 292 may include a rectifier (e.g., diode, diode bridge) and power storage element (e.g., capacitor, ultra-capacitor), collectively 294, to recover electrical power from the interrogation signal 274a, to power the circuitry of the passive wireless RFID transponder or tag 286.

The passive wireless RFID transponder or tag 286 may include a logic circuit 296 which controls operation of the passive wireless RFID transponder or tag 286. The logic circuit 296 may take the form of an ASIC or other logic circuitry or microcontroller, which may operate as a state machine, executing a set of instructions. The passive wireless RFID transponder or tag 286 may include one or more nontransitory readable media (collectively 298). For example, the passive wireless RFID transponder or tag 286 may include one or more read-only nonvolatile storage medium or memory such as ROM 298a. The ROM 298a may, for example, store one or more unique wireless transponder identifiers ID₁, . . . , ID_{N}. Also for example, the passive wireless RFID transponder or tag 286 may include one or more read/write nonvolatile storage medium or memory, such as EEPROM 298b. The EEPROM 298b may, for example, store executable instructions and/or data. Further, instructions and/or data may be written to the EEPROM 298b after distribution of the passive wireless RFID transponder or tag 286 by a manufacturer, for example written to by a retailer or customer. The passive wireless RFID transponder or tag 286 may include one or more communications channels or buses 299 communicatively coupling the various components thereof. Optionally, the passive wireless RFID transponder or tag 286 may advantageously include one or more manually actuatable switches IN₁, . . . , IN_{N} which are selectively manually actuatable by a customer. Implementations with a signal switch IN₁ allow the customer to easily control whether or not the passive wireless RFID transponder or tag 286 responds (i.e., transmits a response or return signal 274b) to an interrogation signal 274a.

For example, the switch IN₁ may take the form of, or function as, normally open switch. The switch IN₁ is normally in an open state, unless actuated into a closed state. When in the open state, the switch IN₁ prevents the passive wireless RFID transponder or tag 286 from responding to an interrogation signal 274a. Alternatively, when in the open state, the switch IN₁ may permit the passive wireless RFID transponder or tag 286 to respond to the interrogation signal 274a, however the response or return signal 274b will omit information which specifies an order. For example, the response or return signal 274b will omit the unique wireless transponder identifier ID₁, or order specific information. When in the closed state, the switch IN₁ allows the passive wireless RFID transponder or tag 286 to respond to the interrogation signal 274a. For example, the passive wireless RFID transponder or tag 286 may backscatter a response or return signal 274b which includes or encodes the unique wireless transponder identifier ID₁, or order specific information.

Implementations with multiple switches IN₁, . . . , IN_{N} allow the customer to easily control not only whether or not the passive wireless RFID transponder or tag 286 responds to an interrogation signal 274a, but also the content of that response.

For example, the switches may take the form of, or function as, normally open switches. Such switches are normally in an open state, unless actuated into a closed state. When in the open state, the switch may prevent the passive wireless RFID transponder or tag 286 from responding to an interrogation signal 274a

For example, the switches IN₁, . . . , IN_{N} may take the form of, or function as, normally open switches. The switches IN₁, . . . , IN_{N} are normally in an open state, unless actuated into a closed state. When in the open state, each switch IN₁, . . . , IN_{N} prevents the passive wireless RFID transponder or tag 286 from responding to an interrogation signal 274a with information which specifies a respective order assigned to or associated with the respective switch IN₁, . . . , IN_{N}. When in the closed state, a switch IN₁, . . . , IN_{N} allows the passive wireless RFID transponder or tag 286 to respond to the interrogation signal 274a. For example, the passive wireless RFID transponder or tag 286 may backscatter a response or return signal 274b which includes or encodes the unique wireless transponder identifier ID₁-ID_{N}, or order specific information assigned to or associated with the respective switch IN₁, . . . , IN_{N}. For instance, actuation of a first switch IN₁ may cause the passive wireless RFID transponder or tag 286 to respond to an interrogation signal 274a with a response or return signal 274b which encodes a first unique wireless transponder identifier ID₁ stored in ROM. Also for instance, actuation of an Nth switch IN_{N} may cause the passive wireless RFID transponder or tag 286 to respond to an interrogation signal 274a with a response or return signal 274b which encodes an Nth unique wireless transponder identifier ID_{N} stored in ROM.

The switches IN₁, . . . , IN_{N} may take any of a large variety of forms. For example, the switches IN₁, . . . , IN_{N} may take the form of mechanical switches which require manual movement of one element with respect to another element. Such may for instance take the form of a dome switch, button or key. For example, the switches IN₁, . . . , IN_{N} may take the form of touch sensitive switches. Such may for instance take the form of capacitive or inductive touch sensitive switches, such as those commonly associated with touch panel display screens. The switch(es) IN₁, . . . , IN_{N} may protrude from the remainder of the passive wireless RFID transponder or tag 286, or may be integrally formed therein and possibly demarcated by appropriate non-functional visual markings. The switch(es) IN₁, . . . , IN_{N} are manually actuatable from an exterior of the passive wireless RFID transponder or tag 286, whether by simple contact or touch or by physical displacement of an element. In some implementations, the switch(es) IN₁, . . . , IN_{N} are manually actuatable by a given movement, for example a shaking motion. In some implementations, only a single one of the switch(es) IN₁, . . . , IN_{N} are manually actuatable at a time.

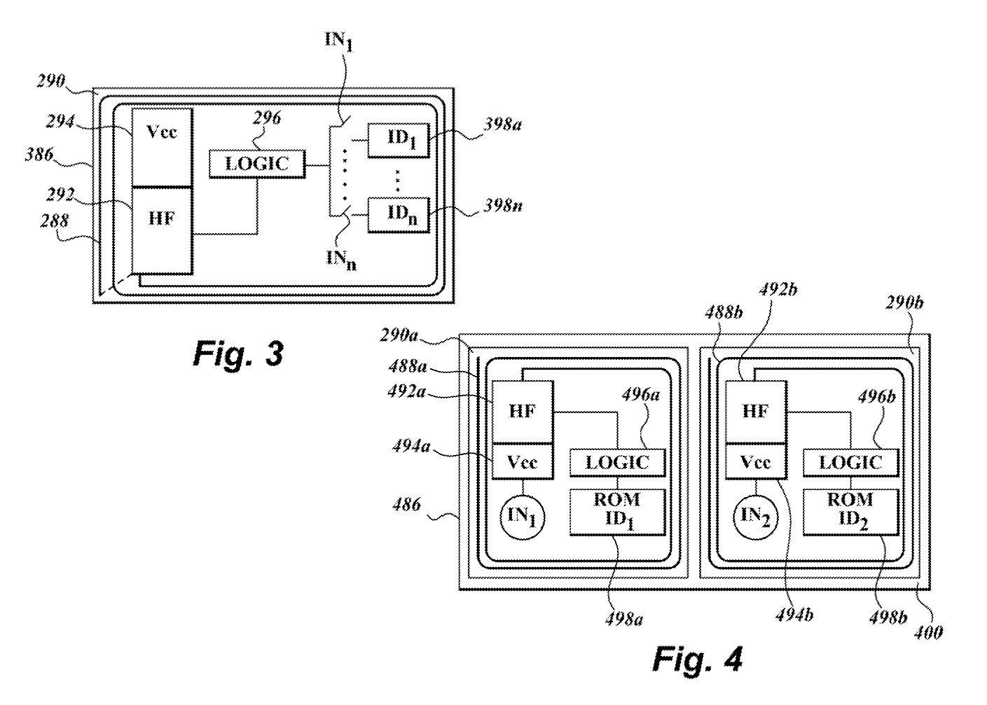

FIG. 3 shows a wireless communications device in the form of a passive wireless transponder 386, according to another illustrated embodiment.

The passive wireless transponder 386 is similar in some respect to the passive wireless transponder 286 (FIG. 2). Only significant differences are discussed below.

In particular, instead of using a ROM 298a to store two or more wireless transponder identifiers, the passive wireless transponder 386 may include a respective nontransitory storage element or structure 398a-398n, each of which stores a respective wireless transponder identifier. Each of the nontransitory storage elements or structures 398a-398n is communicatively coupleable to the logic circuitry 296 via a respective switch IN₁, . . . , IN_{N}. Thus, in response to receipt of an interrogation signal, the passive wireless transponder 386 encodes or imposes the wireless transponder identifier on the return or response signal which corresponds to a respective switch IN₁, . . . , IN_{N} which has been manually actuated, if any, by a customer holding the passive wireless transponder 386.

FIG. 4 shows a wireless communications device in the form of a passive wireless transponder 486, according to another illustrated embodiment.

The passive wireless transponder 486 is similar in some respect to the passive wireless transponder 286 (FIG. 2) and passive wireless transponder 386 (FIG. 3). Only significant differences are discussed below.

In particular, instead of using a single passive RFID transponder or tag circuit to store two or more wireless transponder identifiers, the passive wireless transponder 486 may include two or more distinct RFID transponder or tag circuits, either on a common substrate or in a common package 400. For example, single passive RFID transponders or tags may be coupled in groups of two or more on a single or common substrate 400.

Each distinct RFID transponder or tag circuit includes a respective substrate 290a, 290b. Each distinct RFID transponder or tag circuit includes a respective antenna 488a, 488b, high frequency front end 492a, 492b, rectifier and power storage section 494a, 494b, logic circuit 496a, 496b, switches IN₁, IN₂, and nontransitory storage element or structure such as ROM 498a, 498b, which stores a respective wireless transponder identifier ID₁, ID₂. The various components are carried by the respective substrates 290a, 290b. Each of the ROMs 498a, 498b is communicatively coupleable to the logic circuitry 496a, 496b via a respective switch IN₁, IN₂. Thus, in response to receipt of an interrogation signal, one of the passive wireless transponder or tag circuits encodes or imposes the respective wireless transponder identifier on the return or response signal, dependent on which of the RFID transponder or tag circuits has its respective switch IN₁, . . . , IN_{N} manually actuated, if any, by a customer holding the passive wireless transponder 486.

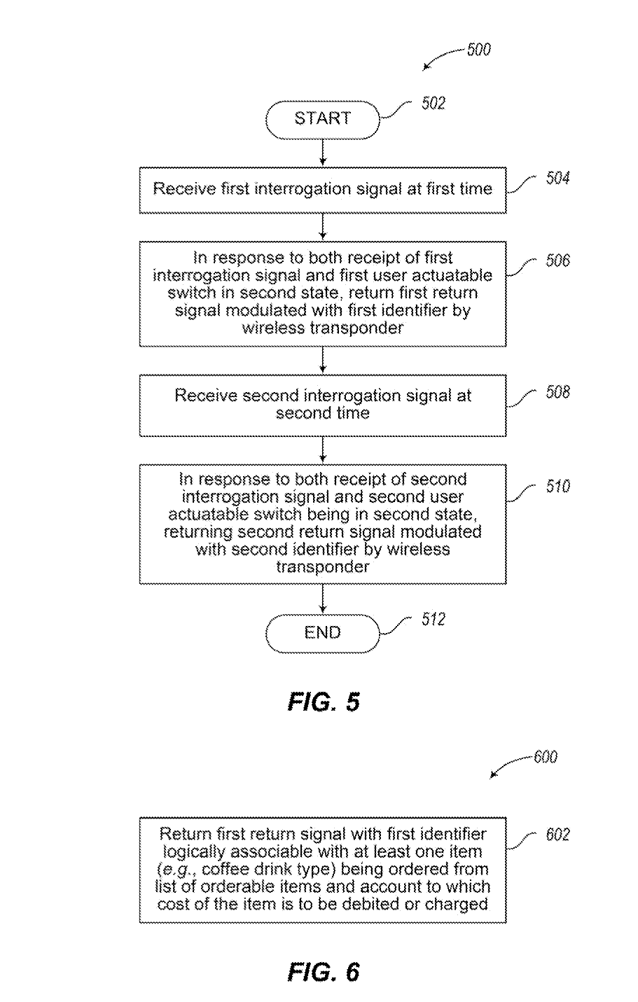

FIG. 5 shows a high level method 500 of operating a wireless communications device, for example a wireless transponder, in an order placement and fulfillment system, according to one illustrated embodiment.

The method 500 starts at 502. For example, the wireless transponder may start the method 500 in response to a power on of the wireless transponder. Alternatively, where the wireless transponder is a passive device, the method 500 is instigated by the receipt of a first interrogation signal, at 504.

At 504, the wireless transponder receives a first interrogation signal at a first time. In some implementations, the first interrogation signal may simply be a carrier wave, which supplies power to a passive wireless transponder. In other implementations, the first interrogation signal may encode information.

At 506, in response to both receipt of the first interrogation signal and a first user actuatable switch of the wireless transponder being in an actuated or closed state, the wireless transponder returns a first return or response signal. The first return or response signal is modulated with a first identifier that is stored in a nontransitory processor-readable medium of the wireless transponder. If the first user actuatable switch had been in an unactuated or open state, the wireless transponder would not supply the first identifier, and may not even respond to the interrogation signal. This supplies sufficient information to register a placement of a first order and to discern the contents of the first order.

Where the wireless transponder has two or more customer actuatable switches, then optionally at 508, the wireless transponder receives a second interrogation signal at second time.

Optionally at 510, in response to both receipt of the second interrogation signal and a second user actuatable switch being in an actuated or closed state, the wireless transponder returns a second return or response signal. The second return or response signal is modulated with a second identifier that is stored in a nontransitory processor-readable medium of the wireless transponder. The second identifier in this case is different from the first identifier, and identifies a different type of order (i.e., specification of ordered items, goods or services differ between the first and the second order).

The method 500 terminates at 512 until called again. Alternatively, the method 500 may repeat, for example, with control returning to 502 or 504. Alternatively, the method 500 may run concurrently with other methods or processes, for example, as one of multiple threads on a multi-threaded processor system.

FIG. 6 shows a low level method 600 of operating a wireless transponder, according to one illustrated embodiment. The method 600 may, for example, be useful in performing the method 500 of FIG. 5.

At 602, the wireless transponder returns a first return or response signal modulated with a first identifier which is logically associable with an item being ordered from a list of orderable items. For example, first identifier may be logically associable with a coffee beverage. The first identifier may directly indicate the items, goods or services that constitute an order, or more typically indirectly indicate the items, goods or services. For example, the first identifier may be mapped via one or more data structures to a customer identifier or customer account identifier, in which the items, goods or services are specified via respective items, goods or services identifiers also via one or more data structures.

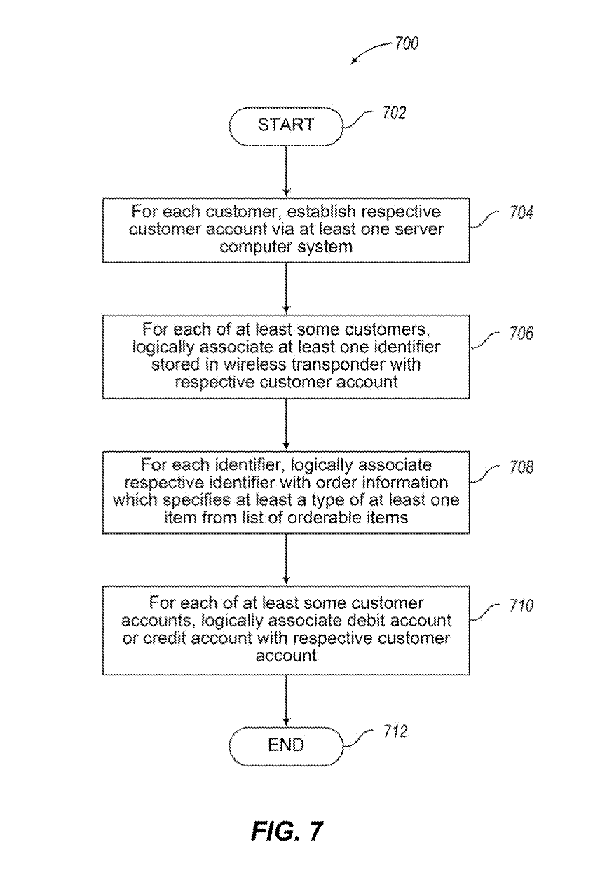

FIG. 7 shows a high level method 700 of operating an order placement and fulfillment system processor-based component, according to one illustrated embodiment, including the setting up of customer accounts.

The method 700 starts at 702. For example, the method 700 may start in response to a powering of a computer system, or in response to receipt of a request for a Webpage or Web services.

At 704, for each of a plurality of customers, an order placement and fulfillment subsystem establishes a respective customer account. The order placement and fulfillment subsystem 202 may establish customer accounts in response to requests made by customers via customer communications devices. The order placement and fulfillment subsystem may function as a server computer system, the at least one sever computer including at least one processor and at least one nontransitory processor-readable medium communicatively coupled to the at least one processor.

At 706, for each of at least some of the customers, the order placement and fulfillment subsystem logically associates (i.e., defines a logical relationship in a data structure in nontransitory computer- or processor-readable media) at least one identifier stored in a wireless transponder with the respective customer account.

At 708, for each of the identifiers, the order placement and fulfillment subsystem logically associates the respective identifier at least with order information which specifies at least a type of at least one item from a list of orderable items.

Optionally at 710, for each of at least some of the customer accounts, the order placement and fulfillment subsystem logically associates at least one of a debit account or credit account with the respective customer account by the at least one server computer system. For example, the order placement and fulfillment subsystem may store account identifiers, expiration dates, security codes, credit or debit limits, and/or mailing addresses to one or more data structures in nontransitory computer- or processor-readable media.

The method 700 terminates at 712 until called again. Alternatively, the method 700 may repeat, for example, with control returning to 702 or 704. Alternatively, the method 700 may run concurrently with other methods or processes, for example, as one of multiple threads on a multi-threaded processor system.

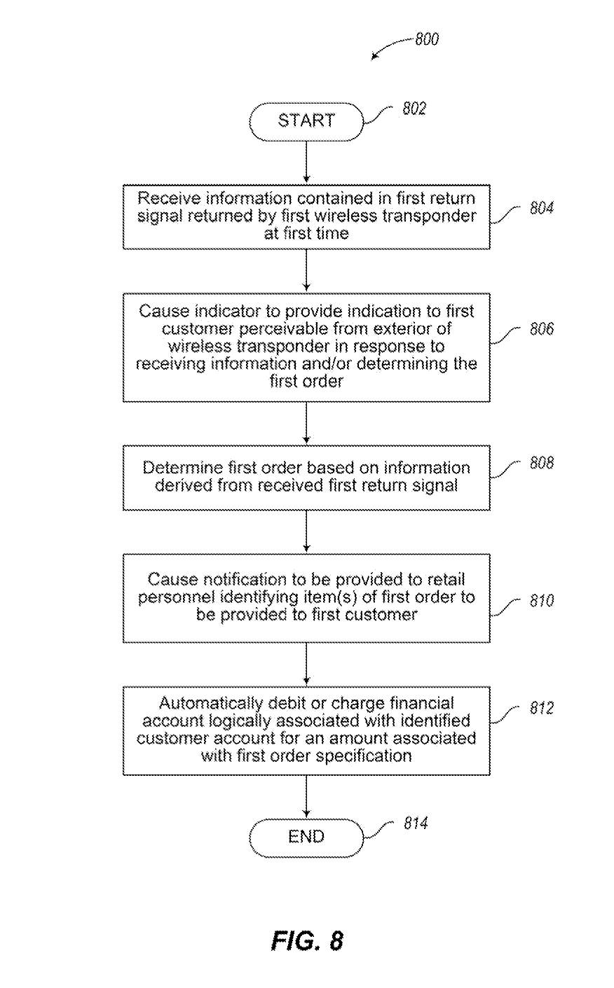

FIG. 8 shows a high level method 800 of operating of an order placement and fulfillment system processor-based component, according to one illustrated embodiment, including the interrogation of wireless transponders and automated order placement.

The method 800 starts at 802. For example, the method 800 may start on a powering of the order placement and fulfillment subsystems and/or interrogator system.

At 804, the order placement and fulfillment subsystems and/or interrogator system receives information contained in a first return signal returned by a first wireless transponder at a first time.

Optionally at 806, the order placement and fulfillment subsystems and/or interrogator system causes at least one indicator to provide an indication perceivable from an exterior of the wireless transponder in response to at least one of receiving information or determining the first order. For example, one or more presentation or acknowledgement indicators of the interrogation system may provide a visual and/or aural acknowledgement.

At 808, the order placement and fulfillment subsystems determines a first order based on information derived from the received first return signal. For example, the order placement and fulfillment subsystems and/or interrogator system may determine the first order by identifying a respective customer account based on the information derived from the received first return signal. The order placement and fulfillment subsystems may then identify a saved first order specification, which is logically associated with the respective customer account in a data structure in nontransitory computer- or processor-readable media. Also for example, the order placement and fulfillment subsystems may identify a respective customer account based on the information derived from the received first return signal, and then select between a saved first order specification and a saved second order specification, each logically associated with the respective customer account, based at least in part of the derived information.

At 810, the order placement and fulfillment subsystems may cause a notification to be provided to retail personnel identifying at least one item of the first order to be provided to a first customer. For example, the order placement and fulfillment subsystems may transmit notification to a point-of-sale location from the server computer system which is remotely located from the point-of-sale location. The presentation to the retail personnel may be visual and/or aural, presented via one or more presentation devices.

Optionally at 812, the order placement and fulfillment subsystems may cause automatic debiting or charging a financial account logically associated with the identified customer account for an amount associated with the first order specification. For example, the order placement and fulfillment subsystems may transmit information such as account number and amount of charge to a financial system or database.

The method 800 terminates at 814 until called again. Alternatively, the method 800 may repeat, for example, with control returning to 802 or 804. Alternatively, the method 800 may run concurrently with other methods or processes, for example, as one of multiple threads on a multi-threaded processor system.

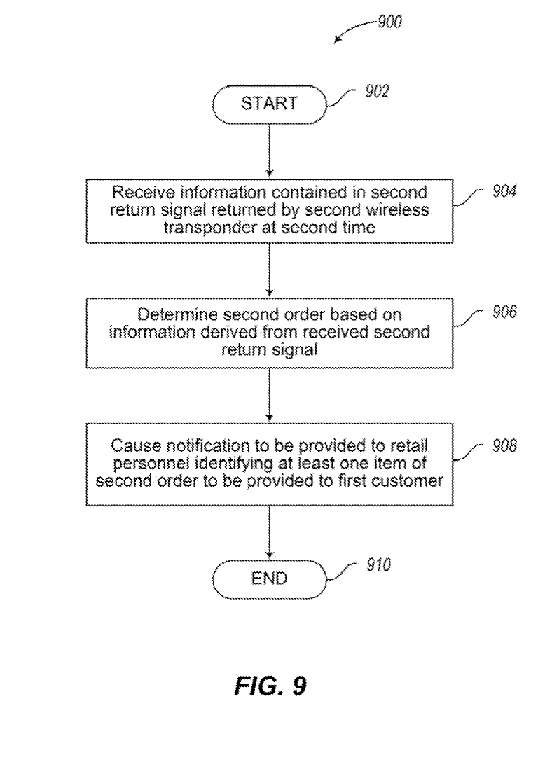

FIG. 9 shows a high level method 900 of operating an order placement and fulfillment system processor-based component, according to one illustrated embodiment. The method 900 may, for example, be performed in conjunction with the method 800 of FIG. 8. The method 900 may be useful where either two different customer with respective wireless transponders wish to place respective orders for different items, or where a single customer with two more wireless transponders wishes to place two or more orders for different items at different times.

The method 900 starts at 902. For example, the method 900 may start on a powering of the order placement and fulfillment subsystems and/or interrogator system.

Following either 810 or 812, the order placement and fulfillment subsystem(s) and/or interrogator system receives information contained in a second return signal returned by a second wireless transponder at a second time, at 904.

At 906, the order placement and fulfillment subsystems and/or interrogator system determines a second order based on information derived from the received second return signal. As previously discussed, an identifier read from a wireless transponder may directly indicate the items, goods or services that constitute an order, or more typically indirectly indicate the items, goods or services. For example, the identifier read from a wireless transponder may be mapped via one or more data structures to a customer identifier or customer account identifier, in which the items, goods or services are specified via respective items, goods or services identifiers also via one or more data structures.

At 908, the order placement and fulfillment subsystems and/or interrogator system causes a notification to be provided to retail personnel identifying at least one item of the second order, where the items of the second order are to be provided to the first customer.

The method 900 terminates at 910 until called again. Alternatively, the method 900 may repeat, for example, with control returning to 902 or 904. Alternatively, the method 900 may run concurrently with other methods or processes, for example, as one of multiple threads on a multi-threaded processor system.

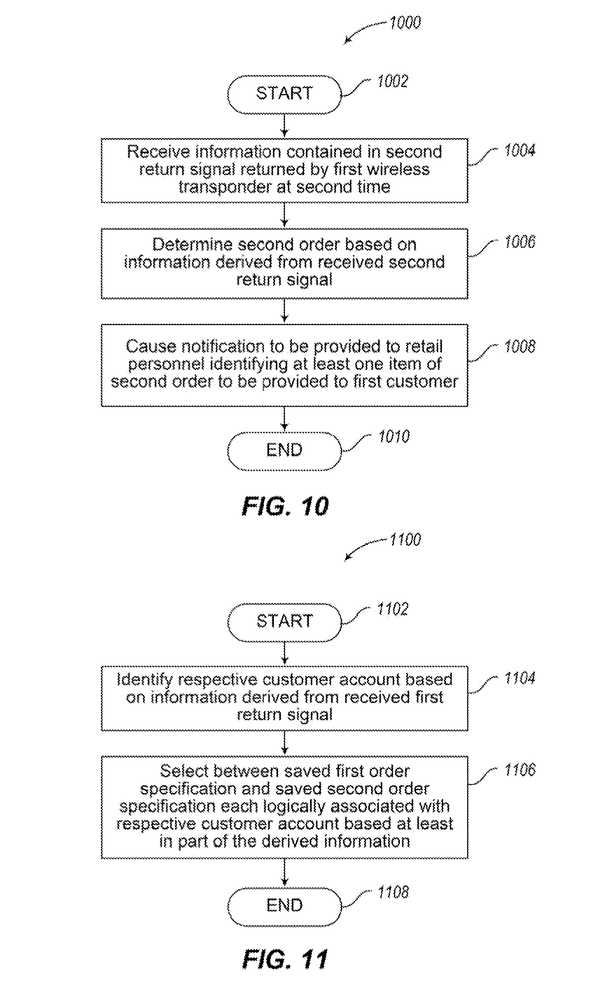

FIG. 10 shows a high level method 1000 of operating an order placement and fulfillment system processor-based component, according to one illustrated embodiment. The method 1000 may, for example, be performed in conjunction with the method 800 of FIG. 8. The method 1000 may be useful where a single customer with a wireless transponder with two or more customer actuatable switches wishes to place two or more orders for different items at different times.

The method 1000 starts at 1002. For example, the method 1000 may start on a powering of the order placement and fulfillment subsystems and/or interrogator system.

Following either 810 or 812, the order placement and fulfillment subsystems and/or interrogator system receives information contained in a second return signal returned by a first wireless transponder at a second time at 1004.

At 1006, the order placement and fulfillment subsystems and/or interrogator system determines a second order based on information derived from the received second return signal. As previously discussed, an identifier read from a wireless transponder may directly indicate the items, goods or services that constitute an order, or more typically indirectly indicate the items, goods or services. For example, the identifier read from a wireless transponder may be mapped via one or more data structures to a customer identifier or customer account identifier, in which the items, goods or services are specified via respective items, goods or services identifiers also via one or more data structures.

At 1008, the order placement and fulfillment subsystems and/or interrogator system causes a notification to be provided to retail personnel identifying at least one item of the second order, the items of the second order to be provided to the retail personnel.

The method 1000 terminates at 1010 until called again. Alternatively, the method 1000 may repeat, for example, with control returning to 1002 or 1004. Alternatively, the evaluation method 1000 may run concurrently with other methods or processes, for example, as one of multiple threads on a multi-threaded processor system.

FIG. 11 shows a low level method 1100 of operating an order placement and fulfillment system processor-based component, according to one illustrated embodiment. The method 1100 may, for example, be performed as part of the method 800 of FIG. 8. The method 1100 may be useful where a customer has defined two or more orders, which may be selected by actuation of one of two or more wireless transponders or actuation of one of two or more manually actuatable switches of a single wireless transponder.

The method 1100 starts at 1102. For example, the method 1100 may start on a powering of the order placement and fulfillment subsystems and/or interrogator system.

At 1104, the order placement and fulfillment subsystems identifies a respective one of the customer accounts based on the information derived from the received first return or response signal. For example, the information derived from the received return or response signal may be a wireless transponder identifier. The wireless transponder identifier may be one of two or more wireless transponder identifiers stored on a wireless transponder. The wireless transponder identifier may correspond to either 1) a single wireless transponder, or 2) a combination of a wireless transponder and a single one of two or more switches of the respective wireless transponder. Thus, the wireless transponder uniquely identifies a wireless transponder, and in some instances may also uniquely identify a switch state on the wireless transponder. A mapping or other logical relationship between wireless transponder identifiers and customer identifiers or customer account identifiers may be stored in one or more data structures in nontransitory computer- or processor-readable media. Alternatively, a mapping or other logical relationship between wireless transponder identifiers and a plurality of orders stored under a customer identifier or customer account identifier may be stored in one or more data structures in nontransitory computer- or processor-readable media.

At 1106, the order placement and fulfillment subsystems select between a saved first order specification and at least a saved second order specification. Each of the order specifications are logically associated with the respective customer account, based at least in part of the derived information. The logical association may again be a relationship stored in one or more data structures in one or more nontransitory computer- or processor-readable media.

The method 1100 terminates at 1108 until called again. Alternatively, the method 1100 may repeat, for example, with control returning to 1102 or 1104. Alternatively, the method 1100 may run concurrently with other methods or processes, for example, as one of multiple threads on a multi-threaded processor system.

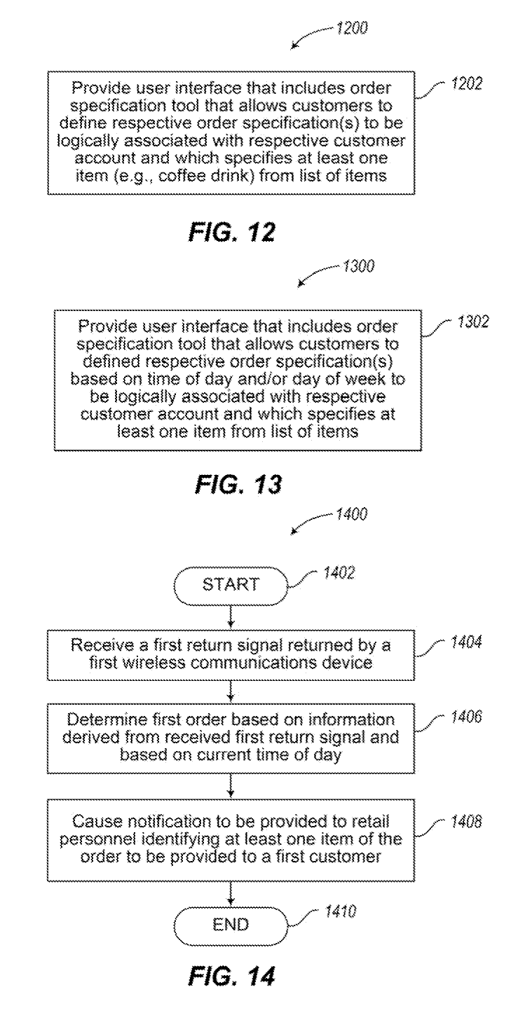

FIG. 12 shows a high level method 1200 of operation of an order placement and fulfillment system processor-based component, according to one illustrated embodiment, allowing customers to logically associate customized orders with wireless transponders via customer accounts.

At 1202, an order placement and fulfillment subsystem provides a user interface that includes an order specification tool that allows a respective customer to define at least one respective order specification to be logically associated with a respective customer account and which specifies at least one item from a list of items. For example, the customer may logically associate an order that specifies at least one type of coffee drink from a menu of available beverage and food items with the customer account. The order placement and fulfillment subsystem may function as a server to provide the user interface to a customer communications device.

FIG. 13 shows a high level method 1300 of an order placement and fulfillment system processor-based component, according to one illustrated embodiment, allowing customers to logically associate customized orders with wireless transponders via customer accounts on a date or time basis.

At 1302, an order placement and fulfillment subsystem provides a user interface that includes an order specification tool that allows a respective customer to define at least one respective order specification based on at least one of a time of day or day of week to be logically associated with a respective customer account and which specifies at least one item from a list of items. For example, the customer may logically associate an order that specifies at least one type of coffee drink from a menu of available beverage and food items and a day of week and/or time of day with the customer account. The order placement and fulfillment subsystem may function as a server to provide the user interface to a customer communications device.

FIG. 14 shows a high level method 1000 of operating an order placement and fulfillment system processor-based component, according to one illustrated embodiment. The method 1400 may, for example, be performed in conjunction with the method 800 of FIG. 8. The method 1400 may be useful where a customer defines two or more orders, and expresses a preference based on day of week and/or time of day.

The method 1400 starts at 1402. For example, the method 1400 may start on a powering of the order placement and fulfillment subsystem(s) and/or interrogator system.

At 1404, an order placement and fulfillment subsystem or interrogation system receives a first return signal returned by a first wireless communications device.

At 1406, the order placement and fulfillment subsystem determines a first order based on information derived from the received first return signal and based on at least one of a current time of day or a current day of week.

For example, the information derived from the received return or response signal may be a wireless transponder identifier. A mapping or other logical relationship between wireless transponder identifiers and customer identifiers or customer account identifiers may be stored in one or more data structures in nontransitory computer- or processor-readable media. The customer account may define a relationship between two or more orders and respective day(s) of the week and time(s) for which that order applies if a return or response signal logically related to the given customer account is received. Thus, the order placement and fulfillment subsystem may first identify a corresponding customer account, then select between two or more defined orders for that customer account based on a day and/or time of receipt of the return or response signal. For example, return or response signals related to a given customer account which are received on weekday mornings may be automatically determined to be an order for a hot coffee beverage, based on customer predefined preferences. Return or response signals related to the same given customer account which are received on weekday afternoons may be automatically determined to be an order for a cold coffee beverage based on customer predefined preferences.

At 1408, the order placement and fulfillment subsystem causes a notification to be provided to retail personnel identifying at least one item of the order to be provided to a first customer.

The method 1400 terminates at 1410 until called again. Alternatively, the method 1400 may repeat, for example, with control returning to 1402 or 1404. Alternatively, the method 1400 may run concurrently with other methods or processes, for example, as one of multiple threads on a multi-threaded processor system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wireless transponder, comprising;
at least one antenna;
at least one nontransitory medium that stores at least a first identifier;
at least a first user actuatable switch having a first state and at least a second state, the first user actuatable switch selectively operable by a person in possession of the wireless transponder to place the first user actuatable switch into at least one of the first or the second states; and
at least one circuit coupled to the antenna and operable to modulate a return signal with information indicative of the stored first identifier only when the first user actuatable switch is in the second state.

2. The wireless transponder of claim 1 wherein the at least one circuit includes a radio front end with at least one rectifier that derives direct current power from an interrogation signal received via the antenna and which includes at least one storage capacitor electrically coupled to the at least one rectifier to temporarily store the derived direct current power, the wireless transponder is a passive wireless transponder, and the at least one circuit modulates the return signal with information indicative of the stored first identifier only in response to a combination of receipt of the interrogation signal and the first user actuatable switch being in the second state.

3. The wireless transponder of claim 1 wherein the at least one switch is a normally open switch which is normally in the first state while not activated by the person in possession of the wireless transponder.

4. The wireless transponder of claim 1 wherein the first identifier is logically associable with an item being ordered from a list of orderable items.

5. The wireless transponder of claim 1 wherein the first identifier is logically associable with a coffee drink type being ordered from a list of orderable items.

6. The wireless transponder of claim 1 wherein the first identifier is logically associable with a combination of items being ordered from a list of orderable items.

7. The wireless transponder of claim 1 wherein the first identifier is logically associable uniquely with a combination of at least one item being ordered and an account to which a cost of the item is to be debited.

8. The wireless transponder of claim 1 wherein the first identifier is logically associable uniquely with a combination of at least one item being ordered and an account to which a cost of the item is to be charged.

9. The wireless transponder of claim 1 wherein the at least one nontransitory medium stores at least a second identifier, and further comprising:
at least a second user actuatable switch having a first state and at least a second state, the second user actuatable switch selectively operable by the person in possession of the wireless transponder to place the second user actuatable switch into at least one of the first or the second states, and wherein the at least one circuit is operable to modulate the return signal with information indicative of the stored second identifier only when the second user actuatable switch is in the second state.

10. The wireless transponder of claim 1 wherein the at least one nontransitory medium stores at least a second identifier, and further comprising:
at least a second user actuatable switch having a first state and at least a second state, the second user actuatable switch selectively operable by the person in possession of the wireless transponder to momentarily place the second user actuatable switch into the second state from the first state, and wherein the at least one circuit is operable to modulate the return signal with information indicative of the stored second identifier only in response to receipt of an interrogation signal and the second user actuatable switch having been momentarily placed into the second state.

11. The wireless transponder of claim 1 wherein the first identifier is logically associable with a first set of items being ordered from a list of orderable items, and the second identifier is logically associable with a second set of items being ordered from the list of orderable items, the second set of items different at least in part from the first set of items, each of the first and the second sets having at least one respective item.

12. The wireless transponder of claim 1 wherein the first identifier is logically associable with a first type of coffee drink, and the second identifier is logically associable with a second type of coffee drink.

13. The wireless transponder of claim 1, further comprising:
a housing; and
a human-readable indicia carried by the housing and indicative of a retailer from which an item may be ordered by actuation of at least the first user actuatable switch.

14. The wireless transponder of claim 1, further comprising:
a housing; and
a human-readable indicia carried by the housing and indicative of an item which may be ordered by actuation of at least the first user actuatable switch.

15. The wireless transponder of claim 1, further comprising:
a housing, wherein the first user actuatable switch is operable in response to a touch on a portion of the housing.

16. The wireless transponder of claim 1, further comprising:
a housing, wherein the first user actuatable switch is engageable from an exterior of the housing.

17. A method of operating a wireless transponder, comprising:
receiving a first interrogation signal at a first time; and
in response to both receipt of the first interrogation signal and a first user actuatable switch being in a second state, the second state different from a first state of the first user actuatable switch, returning a first return signal modulated with a first identifier that is stored in a nontransitory processor-readable medium of the wireless transponder.

18. The method of claim 17, further comprising:
receiving a second interrogation signal at a second time; and
in response to both receipt of the second interrogation signal and a second user actuatable switch being in a second state, the second state different from a first state of the second user actuatable switch, returning a second return signal modulated with a second identifier that is stored in a nontransitory processor-readable medium of the wireless transponder.

19. The method of claim 17 wherein returning a first return signal modulated with a first identifier includes returning the first return signal with the first identifier which is logically associable with an item being ordered from a list of orderable items.

20. The method of claim 17 wherein returning a first return signal modulated with a first identifier includes returning the first return signal with the first identifier which is logically associable with a coffee drink type being ordered from a list of orderable items.

21. The method of claim 17 wherein returning a first return signal modulated with a first identifier includes returning the first return signal with the first identifier which is logically associable uniquely with a combination of at least one item being ordered and an account to which a cost of the item is to be at least one of debited or charged.

22. A method of operating a retail fulfillment system, the method comprising:
for each of a plurality of customers, establishing a respective customer account via at least one computer system, the at least one computer including at least one processor and at least one nontransitory processor-readable medium communicatively coupled to the at least one processor;
for each of at least some of the customers, logically associating at least one identifier stored in a wireless transponder with the respective customer account; and
for each of the identifiers, logically associating the respective identifier at least with order information which specifies at least a type of at least one item from a list of orderable items.

23. The method of claim 22, further comprising:
for each of at least some of the customer accounts, logically associating at least one of a debit account or credit account with the respective customer account by the at least one computer system.

24. The method of claim 22, further comprising:
receiving information contained in a first return signal returned by a first wireless transponder at a first time;
determining a first order based on information derived from the received first return signal; and
causing a notification to be provided identifying at least one item of the first order to be provided to a first customer.

25. The method of claim 24 wherein determining a first order based on derived information from the received first return signal includes identifying a respective one of the customer accounts based on the information derived from the received first return signal, and identifying a saved first order specification logically associated with the respective customer account.

26. The method of claim 24, further comprising:
automatically debiting or charging a financial account logically associated with the identified customer account for an amount associated with the first order specification.

27. The method of claim 24 wherein determining a first order based on derived information from the received first return signal includes identifying a respective one of the customer accounts based on the information derived from the received first return signal, and selecting between a saved first order specification and a saved second order specification, each logically associated with the respective customer account, based at least in part of the derived information.

28. The method of claim 24, further comprising:
receiving information contained in a second return signal returned by a second wireless transponder at a second time;
determining a second order based on information derived from the received second return signal; and
causing a notification to be provided identifying at least one item of the second order to be provided to the first customer.

29. The method of claim 24, further comprising:
receiving information contained in a second return signal returned by the first wireless transponder at a second time;
determining a second order based on information derived from the received second return signal; and
causing a notification to be provided identifying at least one item of the second order to be provided to the first customer.

30. The method of claim 24 wherein receiving information contained in a first return signal returned by a first wireless transponder at a first time includes receiving information at the computer system from an interrogation system located at least proximate an entrance or a point-of-sale location, the computer system remotely located from the point-of-sale location.

31. The method of claim 24 wherein causing a notification to be provided identifying at least one item of the first order to be provided to a first customer includes transmitting the notification to a point-of-sale location from the computer system which is remotely located from the point-of-sale location.

32. The wireless transponder of claim 24, further comprising:
causing at least one indicator to provide an indication perceivable from an exterior of the wireless transponder in response to at least one of receiving information or determining the first order.

33. The method of claim 22, further comprising:
providing a user interface that includes an order specification tool that allows a respective customer to define at least one respective order specification to be logically associated with a respective customer account and which specifies at least one item from a list of items.

34. The method of claim 22, further comprising:
providing a user interface that includes an order specification tool that allows a respective customer to define at least one respective order specification to be logically associated with a respective customer account and which specifies at least one type of coffee drink from a menu of available beverage and food items.

35. The method of claim 22, further comprising:
providing a user interface that includes an order specification tool that allows a respective customer to define at least one respective order specification based on at least one of a time of day or day of week to be logically associated with a respective customer account and which specifies at least one item from a list of items.

36. The method of claim 22, further comprising:
receiving a first return signal returned by a first wireless transponder;
determining a first order based on information derived from the received first return signal and based on a current time of day; and
causing a notification to be provided to identify at least one item of the order to be provided to a first customer.

37. The method of claim 22, further comprising:
receiving a first return signal returned by a first wireless communications device;
determining a first order based on information derived from the received first return signal and based on at least one of a current time of day or a current day of week; and
causing a notification to be provided to identify at least one item of the order to be provided to a first customer.

38. A retail fulfillment system, comprising:
at least one computer including at least one processor and at least one nontransitory processor-readable medium communicatively coupled to the at least one processor, the at least one computer:
for each of a plurality of customers, establishes a respective customer account via at least one computer system;
for each of at least some of the customers, logically associates at least one identifier stored in a wireless transponder with the respective customer account; and
for each of the identifiers, logically associates the respective identifier at least with order information which specifies at least a type of at least one item from a list of orderable items.

39. The retail fulfillment system of claim 38 wherein for each of at least some of the customer accounts, the at least one computer system logically associates at least one of a debit account or credit account with the respective customer account.

40. The retail fulfillment system of claim 38 wherein the at least one computer system:
receives information contained in a first return signal returned by a first wireless transponder at a first time;
determines a first order based on information derived from the received first return signal; and
causes a notification to be provided identifying at least one item of the first order to be provided to a first customer.

41. The retail fulfillment system of claim 40 wherein the at least one computer system identifies a respective one of the customer accounts based on the information derived from the received first return signal, and identifies a saved first order specification logically associated with the respective customer account.

42. The retail fulfillment system of claim 40 wherein the at least one computer system:
automatically debits or charges a financial account logically associated with the identified customer account for an amount associated with the first order specification.

43. The retail fulfillment system of claim 40 wherein the at least one computer system identifies a respective one of the customer accounts based on the information derived from the received first return signal, and selects between a saved first order specification and a saved second order specification, each logically associated with the respective customer account, based at least in part of the derived information.

44. The retail fulfillment system of claim 40 wherein the at least one computer system:
receives information contained in a second return signal returned by a second wireless transponder at a second time;
determines a second order based on information derived from the received second return signal; and
causes a notification to be provided identifying at least one item of the second order to be provided to the first customer.

45. The retail fulfillment system of claim 40 wherein the at least one computer system:
receives information contained in a second return signal returned by the first wireless transponder at a second time;
determines a second order based on information derived from the received second return signal; and
causes a notification to be provided identifying at least one item of the second order to be provided to the first customer.

46. The retail fulfillment system of claim 40 wherein the at least one computer system receives information at the computer system from an interrogation system located at least proximate an entrance of a point-of-sale location, the computer system which is remotely located from the point-of-sale location.

47. The retail fulfillment system of claim 40 wherein the at least one computer system transmits the notification to a point-of-sale location from the computer system which is remotely located from the point-of-sale location.

48. The retail fulfillment system of claim 38 wherein the at least one computer system:
provides a user interface that includes an order specification tool that allows a respective customer to define at least one respective order specification to be logically associated with a respective customer account and which specifies at least one item from a list of items.

49. The retail fulfillment system of claim 38 wherein the at least one computer system:
provides a user interface that includes an order specification tool that allows a respective customer to define at least one respective order specification to be logically associated with a respective customer account and which specifies at least one type of coffee drink from a menu of available beverage and food items.

50. The retail fulfillment system of claim 38 wherein the at least one computer system:
provides a user interface that includes an order specification tool that allows a respective customer to define at least one respective order specification based on a time of day to be logically associated with a respective customer account and which specifies at least one item from a list of items.

51. The retail fulfillment system of claim 38 wherein the at least one computer system:
receives a first return signal returned by a first wireless transponder;
determines a first order based on information derived from the received first return signal and based on a current time of day; and
causes a notification to be provided to identify at least one item of the order to be provided to a first customer.

52. The retail fulfillment system of claim 38 wherein the at least one computer system:
receives a first return signal returned by a first wireless communications device;
determines a first order based on information derived from the received first return signal and based on at least one of a current time of day or a current day of week; and
causes a notification to be provided to identify at least one item of the order to be provided to a first customer.
